(19) United States
(12) Patent Application Publication
(10) Pub. No.: US 2025/0065634 A1
(43) Pub. Date: Feb. 27, 2025

(54) Tempering Device and Method for Tempering Ink for an Ink Printer

(71) Applicant: Canon Production Printing Holding B.V., Venlo (NL)

(72) Inventors: Florian Hitzlsperger, Poing (DE); Christoph Rummelsberger, Ismaning (DE); Ulrich Stöckle, Germering (DE); Arjan van der Bos, Beuningen (NL); Jeroen Cox, Roermond (NL)

(21) Appl. No.: 18/813,350

(22) Filed: Aug. 23, 2024

(30) Foreign Application Priority Data
Aug. 24, 2023 (DE) 10 2023 122 687.8

(51) Int. Cl. B41J 2/175; B41J 2/195; B41J 29/377; G05D 7/06; G05D 23/19

(52) U.S. Cl. CPC B41J 2/175; B41J 2/195; B41J 29/377; G05D 7/0623; G05D 23/1904

(57) ABSTRACT

A tempering device has a fluid source that has a tempering fluid at a predetermined temperature level. The tempering fluid is supplied to a regulating device that controls a volumetric flow per time period of the tempering fluid depending on a measured real value of the ink temperature. The tempering fluid is supplied to a heat exchanger in which the heat of the tempering fluid is transferred to the ink in order to gradually temper the ink to nominal temperature. The desired nominal temperature of the ink is regulated in that the ink temperature is measured after the heat exchanger and is fed back as a real value to the regulating device, where a volumetric flow is adjusted depending on the difference between real value and nominal value. The ink tempered in such a way is supplied to a printing unit of the ink printer for printing to a printing substrate.

### CROSS-REFERENCE TO RELATED APPLICATION

This application claims priority to German Patent Application No. 10 2023 122 687.8 filed Aug. 24, 2023, the disclosure of which is hereby incorporated by reference in its entirety.

### BACKGROUND OF THE INVENTION

### Field of the Invention

The invention relates to a tempering device for tempering ink for a high-capacity ink printer. The invention also relates to a method for tempering ink for a high-capacity ink printer.

### Description of Related Art

Ink printers can be used for single-color or multicolor printing to a recording medium made from the most varied materials, for example paper. The design of such ink printing apparatuses is sufficiently known. In particular, digital high-speed ink printers are known in which, to generate a print image, ink droplets are ejected from nozzles of a print head of a printing unit onto a rapidly moving recording medium.

Such high-capacity ink printers should be capable of printing with high print quality. Different ambient temperatures can, of course, prevail at the installation site of the ink printer, which ambient temperatures may, of course, also change during operation. The ambient temperature at the site of the ink printer can feasibly be between 15° and 45° C., which can possibly influence the components of the ink printer, for example the ink, and therewith can negatively affect the print quality. For a high print quality, there is the need to maintain the ink at a correspondingly necessary operating temperature level, wherein only small temperature fluctuations within a narrow tolerance range of, for example, +1° C. around the desired operating temperature of the ink should be tolerable.

From the disclosure of document DE 10 2007 043 644 A1, for printing machines a tempering apparatus is known that serves to temper defined parts or fluids of a rotary printing machine. A respective tempering agent loop is hereby provided for cold water and warm water, the temperatures of which can be controlled and/or regulated independently of one another. In order to temper defined parts of the machine with a liquid, warm water and cold water are mixed accordingly until the desired temperature is achieved. The tempered mixture is then conducted in a consumption loop directly to the corresponding parts in order to cool or preheat these. Unused liquid is respectively supplied back to corresponding liquid storages of the two tempering circuits via a return.

Instead of the hydraulic mixing of the two tempering agent circuits, a heat exchanger can also be connected with a consumption loop of the printing machine, whereby the circuits are hydraulically separated from one another. The cold water loop thus, as a fountain solution, serves is connected with the parts to be cooled. The cool fountain solution is then sprayed directly onto rollers of the printing machine for cooling.

A cooling device for rollers or print group cylinders for a printing machine is known from the patent document EP 1 870 238 B1. A loop to be tempered is fed from two loops of different temperature, depending on the external temperature. Rollers or printing cylinders can thus be cooled to below the ambient or external temperature. A heat exchanger can be thermally coupled directly to the component to be tempered in a supply loop for supplying tempering agent at the desired temperature level. A mixture of both can additionally be fed as a tempering agent at a desired temperature level. All tempered print group cylinders, rollers etc. in the printing machine can thus be cooled via direct contact. The device also has heat recovery means via which energy from heat flows can be recovered for the purposes of heating the tempering agent storage.

Given the known tempering apparatuses, components of the printing machines are tempered directly by a mixture of the cooling agent and the heating agent, in that they come into contact with the mixture. It can thereby occur that the parts become too hot or too cold, in particular if a cooling/heating unit should fail. Ink could not be tempered with such a device, since the ink would be diluted with the cooling agent and would no longer be usable.

If ink is cooled or heated, for example with NTC thermistors or PTC thermistors, this may lead to the situation that the very sensitive ink is heated above its maximum allowable temperature (at which volatile substances in the ink vaporize) or freezes (viscosity can become too high) in the event of a malfunction. Since the newest inks are very temperature-sensitive, these should never be warmed above 45° C. Important constituents of the ink will already volatilize at such high temperatures. Local temperature elevations (hot spots) should also not be generated with electronic heating elements, since then the ink will become unusable, or at least a markedly degraded print image would be delivered and the print image would be starkly negatively affected, at least in regions.

### SUMMARY OF THE INVENTION

It is an object of the invention to achieve a simple tempering device and a method for tempering ink for an ink printer, given which the ink to be printed should be maintained at an optimally consistent and specified temperature value during the printing.

This object is achieved for a tempering device via the features as described herein, and for a method via the features as described herein.

The tempering device has a fluid source with a tempering fluid that is pre-tempered to a predetermined temperature and is provided at an outflow of the fluid source. A regulating device receives the tempering fluid from the fluid source at its input. A control unit controls the mass throughput of the supplied tempering fluid depending on a measured temperature of the ink to be tempered as a control variable, and supplies this to a fluid loop of a heat exchanger.

The heat exchanger has the fluid loop with the tempering fluid, and separate therefrom an ink loop with ink. In the heat exchanger, heat is transferred from the fluid loop to the ink loop in order to temper the ink to a desired nominal temperature. For this purpose, a temperature sensor is arranged after the heat exchanger, which temperature sensor measures the temperature of the ink as a real value and feeds the real value back to the regulating device in order to regulate the temperature of the ink to its desired value. The ink tempered in such a way is supplied to a printing unit of the ink printer.

In a method for operating an ink tempering device for an ink printer having a tempering device, a tempering fluid with a predetermined temperature is prepared and supplied to a regulating device. In the regulating device, a volumetric flow is set per time period. This tempering fluid is then brought into thermal contact with ink in a heat exchanger in order to temper the ink to be printed to a desired operating temperature. The real value of the ink that is adjusted in such a way is measured and fed back to the regulating device. The volumetric flow is thus regulated such that the ink temperature assumes the desired nominal value.

This device and this method have the advantage that the ink to be tempered is physically separate from the tempering fluid upon tempering and is thereby not “watered down.” If the temperature of the tempering fluid is set in advance so high that it is always lower than the maximum allowable ink temperature, an overheating of the ink by the tempering device can be avoided even given a malfunction, since otherwise volatile components of the ink would be evaporated. The ink cannot thereby be damaged.

Also, only a single temperable fluid source is required for the tempering of different inks. In addition to this, the tempering device has the advantage that conduit lengths for the tempering fluid have no influence on the accuracy of the regulation. The temperature of the ink can be raised rapidly. Different ink temperatures can also be set for different inks given only one fluid source. Moreover, relatively few electronic modules are required for the temperature regulation.

It is thus advantageous if the heat exchanger is a plate heat exchanger. Heat can then be transferred to the ink over a large area, and the heat exchanger operates especially effectively.

The tempering fluid can be water to which possible additives are added so that, over time, no molds or other contaminants arise in the tempering fluid that would degrade the properties of the water as a tempering fluid. Water has the advantage that it is environmentally friendly and is available in sufficient quantity.

The fluid source has a heating element and/or a cooling element as a tempering element via which the tempering fluid is tempered to a predetermined fluid temperature. The tempering fluid can thus assume any arbitrary desired temperature that is suitable for tempering the ink.

The fluid source can be fed from the water supply at the printer operator. The fluid source can thus be connected to a warm water tap or a cold water tap. However, care should then be taken that the warm water temperature is not too hot or the cold water temperature too cold, even if the water in the fluid source is tempered.

The tempering device is thus of simple design, and only a single fluid source is necessary that provides a fluid with a desired temperature for all connected regulating devices having heat exchanger and parts of the ink printer for the respective ink to be printed. Simple components, such as fluid reservoir, heating element, and/or cooling element are sufficient for tempering the fluid.

It is particularly advantageous if a temperature sensor measures the real temperature of the ink directly in the ink (and not externally at the fluid conduits) at the ink exit of the heat exchanger or afterward, and returns the measured value as a real value to the regulating device so that the mass throughput can be controlled/regulated accordingly. Since the real value is them measured more accurately, this improves the regulation with respect to accuracy and control rate.

If the control unit of the regulating device is a PI controller (proportional-integral controller), the proportional valve controlled therewith can regulate the flow rate quickly and simply via the regulating device (volumetric flow per time period), corresponding to the difference between real value and nominal value.

### BRIEF DESCRIPTION OF THE INVENTION

The terms FIG., FIGS., FIGURE, and FIGURES are used interchangeably in the specification to refer to the corresponding figures in the drawings.

Exemplary embodiments of the invention are explained in detail in the following using schematic drawings. Shown are:

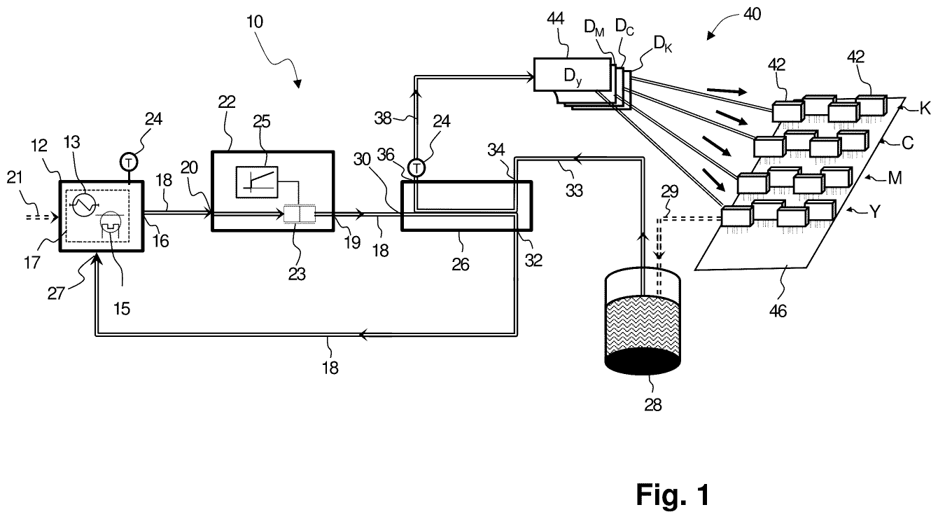

FIG. 1 a block diagram of a tempering device according to the invention,

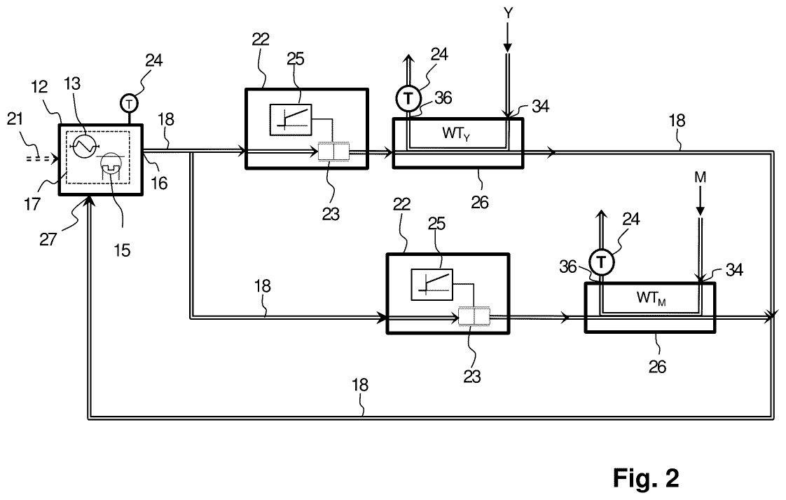

FIG. 2 a block diagram of a tempering device according to FIG. 1 that controls a plurality of ink loops, and

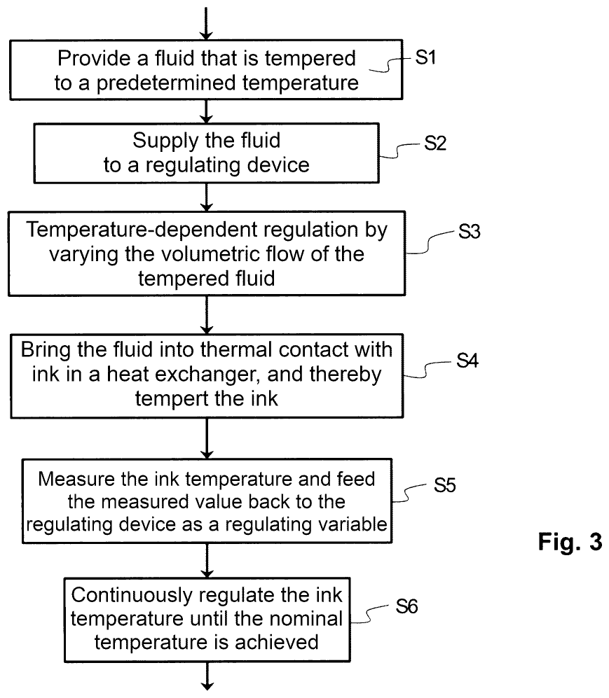

FIG. 3 a workflow diagram for a method for operating a tempering device for ink for an ink printer that has a tempering device according to FIG. 1 or 2.

### DESCRIPTION OF THE INVENTION

In the following, the invention is explained in detail using a plurality of exemplary embodiments of a tempering device for an ink printer, which here in FIG. 1, in a preferred exemplary embodiment, is designed for four-color printing and in FIG. 2 for two-color printing. Instead of ink, other liquid printer's colors can also be used (these are colorant-containing fluids that are transferred onto a printing substrate with the aid of a printing form and are water-based or oil-based, with respective colorants within). Of course, more or fewer colors of inks or fluids may also be used without deviating from the inventive ideas. Only the components that are significant and necessary for the functionality of the invention are explained in detail in Figures, and elements that are functionally the same or are identical are labeled with the same reference characters.

A first exemplary embodiment of a tempering device 10 for tempering ink for an ink printer is depicted in FIG. 1. The tempering device 10 has a fluid source 12 with a fluid (also referred to here as a tempering fluid). Arranged in the fluid source 12 is a fluid reservoir 17 in which the tempering fluid is stored and tempered to a predetermined temperature in operation. For tempering the fluid, the fluid source 12 has at least one heating element 13 and/or at least one cooling element 15. This temperature set in advance is preferably held largely constant during the operation of the ink printer.

The fluid source 12 has at its output side at least one outflow 16 that is connected to a regulating device 22 via a fluid conduit 18 with an input-side inflow 20. In addition to this, the fluid source 12 has a return flow 27 at which tempering fluid can flow back to the fluid source 12. Moreover, the fluid source 12 has a supply connection 21 via which the fluid source 12 can be filled from the outside with a corresponding fluid or be refilled as needed.

Arranged in the regulating device 22 is a control device with a controller 25 and a controllable valve (here a proportional valve 23). The controller 25 controls the mass throughput per time period of the proportional valve 23 depending on a measured ink temperature (this is also referred to as a real temperature or real value). The goal of the regulation is to bring the ink to operating temperature or nominal temperature by feeding back the real temperature and comparing it with the nominal temperature. For printing with the ink printer, the operating temperature is required for an optimal print image. The optimal operating temperature of the ink is specified by the manufacturer.

The corresponding quantity of tempering fluid, which is adjusted to a fixed, predetermined fluid temperature, is supplied via an output 19 and a fluid conduit 18 to a heat exchanger 26 following the regulating device 22.

The heat exchanger 26 has a fluid loop and an ink loop. The tempering fluid flows from the regulating device 22—arriving with a corresponding volumetric flow (quantity per time period) at the input side via a fluid entrance 30—through the fluid loop and is then conducted back to the fluid source 12. The ink to be tempered flows in the ink loop from an ink reservoir—arriving via an ink entrance 34—through the heat exchanger 26, and is supplied at the output side via an ink exit 36 of said heat exchanger 26 to a printing unit 40 for printing the ink.

Fluid loop and ink loop are physically (bodily) separated from one another, for example by a thermally conductive wall, cladding, or partition. However, they are in thermal contact with one another via the wall (not explicitly depicted in Figures) so that thermal energy of the tempering fluid is transferred via the wall to the ink of the ink loop. As a result of the thermal transfer, the ink is tempered via corresponding regulation of the volumetric flow per time period of the tempering fluid flowing through the heat exchanger 26. The ink should be printed only when it has reached its nominal temperature, in order to achieve a correspondingly good print quality of the print image.

At least one temperature sensor 24 that measures the real value of the ink at or after the ink exit 36 of the heat exchanger 26 is required for regulating the ink temperature. For this purpose, the real value is fed back to the regulating device 22 (electrical feedback lines are not shown in FIG. 1 for the sake of clarity).

The ink can be supplied to the heat exchanger 26 via an ink reservoir 28 or a backpressure tank (not explicitly depicted in FIG. 1) via an ink conduit 33. The ink that is not consumed in printing can also be returned from the printing unit 40 to the ink reservoir 28, which is depicted in FIG. 1 by the dashed return conduit 29. As long as the ink is not yet at operating temperature, it can also be conducted-without being printed-into a circuit to the printing unit 40 and from there past the print heads 42, back to the ink reservoir 28.

Before the ink reaches the heat exchanger 26, it can already be pre-tempered and/or also degassed in the ink reservoir 28 or backpressure tank, which especially plays a large role in a good print quality. If it is not pre-tempered, the prevailing ambient temperature for the ink in the ink reservoir 28 emerges as the ink temperature. A pre-tempering is advantageous for a faster regulation, in particular upon starting up/running up the ink printer, since then the regulation up to the operating temperature goes more quickly. The pre-tempering of the ink can take place relatively coarsely, since the precise nominal temperature of the ink is set by the regulation.

The printing unit 40 can have a distribution tank 44 in which the supplied and tempered ink is buffered before the printing. The ink is supplied from the distribution tank 44 to one or more print heads 42, which then can print to a recording medium 46. The distribution tank 44 can also be integrated on or into the housings of the print heads 42. A degassing device that degasses the ink (possibly additionally or anew) can also be comprised in the print heads 42.

A separate regulating device 22, and a heat exchanger 26 connected therewith, is advantageously present for each ink color, as is depicted in FIG. 2 (there the heat exchangers WT_{Y} and WT_{M} are for the yellow and magenta ink). Only a single fluid source 12 is advantageously present via which all ink colors that are used can then be tempered with the aid of a respective separate regulating device 22 and subsequent heat exchanger 26. Each regulating device 22, and indirectly each subsequent heat exchanger 26, is thus fed with the tempering fluid of the single fluid source 12, and the respective ink is thus tempered. In the event that the inks should have different operating temperatures, thus can be affected via the respective control device.

Each regulating device 22 might also be connected to its own fluid source 12. However, this would an increased component cost, which is therefore avoided.

The fluid source 12 is advantageously installed so as to be integrated into the housing of the ink printer. However, the fluid source 12 can also be arranged outside of the ink printer, wherein then corresponding fluid conduits lead to a supply connection for the ink printer.

As heating elements 13, conventional heating elements can be used, for example a heating coil that travels around a conduit and heats the fluid flowing through it. Or an NTC thermistor that is arranged directly in the fluid and heats this to a desired temperature in the event that the fluid source 12 is filled with a fluid that was previously at a cooler temperature level than the desired temperature. For example, this is so if supplying fresh water, which normally has a temperature of from 10°-14° C., for instance.

As cooling elements 15, conventional cooling elements 15 can be used, such as chillers, PTC thermistors, or cooling compressors that cools the fluid in the fluid source 12 to a desired temperature in the event that the fluid source 12 is filled with a fluid that was previously at a warmer temperature level than the desired temperature. For example, this is so if supplying warm water, which normally has a temperature of above 45° C.

Any suitable fluid, be it gas or a liquid, that can conduct heat well upon transport/flowing through corresponding conduits can be used as a tempering fluid. Water is preferably used, which is very environmentally compatible and sufficiently available. Defined additives or chemicals, such as fungicides or biocides, can be added to the water in order to prevent the possible effects that negatively affect the thermal conductivity, for example due to fungal infestation or algae. The fluid source can also be supplied by a separate domestic water connection of the operator at which the ink printer is situated. The drawn mains water (this can be the cold water or the warm water) is then thereby supplied to the fluid reservoir 17 of the fluid source 12. There the water is then tempered corresponding to the requirements for the pre-tempering of the tempering fluid.

The temperature of the tempering fluid is thereby set in advance so that its temperature is higher than the operating temperature of the ink and is approximately the same as or less than the maximum allowable ink temperature. The tempering fluid does not need to be tempered with high accuracy, since the precise adjustment/regulation of the ink temperature is performed by the control loop with regulating device 22 and heat exchanger 26. The tempering fluid is preferably brought to its predetermined fluid temperature upon running up the ink printer or after a printing pause. It is advantageous if printing then does not yet take place, since more control expenditure would be necessary in order to temper the ink with the too-cool tempering fluid. As soon as the fluid has reached its predetermined fluid temperature and the ink has preferably then also reached its operating temperature, the printing can be begun.

If the operating temperature of the ink, as specified by the manufacturer of the ink, should be—for example—32° (ideal temperature of the ink to achieve an optimal print quality), and the specified maximum allowable temperature of the ink should not exceed 40° C., the temperature of the fluid in the fluid source 12 can be set to from approximately 35° C. to approximately 42° C., for example. The ink temperature thus can barely rise above 40° C. due to the heat transfer in the heat exchanger 26, even given failure of the regulation in the regulating device 22, since the temperature of the fluid loses heat somewhat on the way to the heat exchanger 26, and the ink is tempered by the volumetric flow control and the heat transfer in the heat exchanger 26 but is not maintained by its own heating device. This initial temperature of the fluid (here from approximately 35° C. to approximately 42° C.) should be available from the beginning of the regulation so that the regulation functions well and quickly.

Since the fluid temperature is a few degrees higher than the operating temperature of the ink, a greater regulating range/variation range is achieved for the tempering of the ink. This means that the ink can be adjusted in an optimally large range by this volumetric flow regulation, depending on requirement and specification. Given use of a different ink with an operating temperature that is similar (but different therefrom), the same tempering device 10 can thus be used without the components of the tempering device 10 needing to be changed or the fluid source 12 needing to be swapped out. Numerous different inks can thus be used with the tempering device 10.

The regulation of the ink temperature thereby depends on the real temperature of the ink and the difference relative to the nominal temperature. If the difference between the measured real temperature and the nominal temperature is large (as is so initially upon heating up), the volumetric flow (also referred to as a flow rate or mass throughput) per time period of the tempering fluid conveyed through the proportional valve 23 is greater. More energy—given consistent temperature of the fluid—is therewith available in the heat exchanger 26 for heating the ink, and therewith for faster heating of the ink. The closer that the real temperature approaches to the nominal temperature, the smaller the volumetric flow can become, since then less thermal energy is required. The volumetric flow is thereby controlled by the proportional valve 23 depending on real value and nominal value, as well as the nominal/real value difference. The real temperature is thereby measured, and the nominal temperature is predetermined depending on the ink.

A PI controller (proportional-integral controller) can preferably be used as a controller 25, as has long been known from control engineering. The controller 25 integrated into the control loop thereby acts on the proportional valve 23 so that the quantity of tempering fluid flowing through per time period is modified (regulated) corresponding to the difference of nominal value and real value. Of course, other suitable controllers 25, such as P controllers, PID controllers etc., can also be used in order to adjust the required volumetric flow via the proportional valve 23.

In the tempering device 10, the temperature of the tempering fluid is preferably no longer changed after the fluid source 12. Since the regulating device 22 knows the preset temperature of the tempering fluid, the volumetric flow can then be set accordingly depending on the nominal/real value difference. In the event that very long conduits 18, at which a heat loss of the tempering fluid occurs, should be present between fluid source 12 and regulating device 22, on the one hand the fluid temperature in the fluid source 12 can be increased accordingly, or a corresponding correction of the temperature of the tempering fluid can be performed by a heating element 13 or cooling element 15.

For the regulation, the temperature of the ink at or after the ink exit 36 of the heat exchanger 26 is preferably measured and reported back to the controller 25 for the regulation. However, the flow path up to the print head 42 should then be relatively short, and the ink should not suffer too much heat loss along the way. Alternatively, the nominal temperature could be set higher by a correction factor in order to achieve the correct operating temperature of the ink at the print heads 42, depending on the thermal losses.

If the real temperature of the ink is in general measured optimally close to the “consumption,” i.e. directly in the printing unit 40, and preferably directly (possibly also additionally) at the print head 42, the accuracy of the regulation is greatest. In order to provide ink at operating temperature to the printing unit 40, optimally without variation or with barely any variation, the conduit paths of the ink from the heat exchanger 26 to the printing unit 40, and there up to the print head 42, should be kept as short as possible, and preferably should be thermally insulated. This means that the heat exchanger 26 should advantageously be arranged relatively close to the printing unit 40. Otherwise, the actual thermal losses along the ink conduit 38 should also be taken into account as a correction factor in the regulation of the nominal temperature. In such an event, the nominal temperature at the ink exit 36 of the heat exchanger 26 would need to be adjusted higher by the correction factor than the temperature of the ink that is actually required and desired in the printing unit 40. However, the real temperature is preferably measured optimally close to the “consumption” in order to achieve an optimally accurate regulation.

The heat exchanger 26 (also referred to as a thermal transfer medium) is a device that transfers thermal energy from the tempering fluid flowing through the heat exchanger 26 to the ink flowing through the thermal transfer medium. Two material streams (tempering fluid and ink) thus flow through the heat exchanger 26 in order to bring one of the two material streams to a predetermined thermodynamic state as a result of thermal transfer due to the other material stream. The thermal power emitted by the tempering fluid and absorbed by the ink is thereby used in a regulating manner in order to regulate the temperature of the ink to a desired nominal value. The heat is thereby emitted by the warmer material stream and absorbed by the colder materials stream.

The heat exchanger 26 can be of numerous designs; the requirement is that two physically separate material streams (tempering fluid and ink) are present via which thermal energy is transferred from one material stream to the other. The tempering fluid can thus flow in the same direction as the ink stream or also opposite thereto (as is depicted in FIG. 1).

There is also the possibility that the material streams cross, or one material stream is directed in a helix around the other with the aid of a corresponding conduit. It is essential that the two material streams be physically (bodily) separated from one another by a wall or a corresponding dividing component having good thermal conductivity, so that the heat transfer can take place well but the ink is not contaminated or diluted by the tempering fluid. The thermal transfer should also be optimally effective so that the temperature of the ink at the ink exit 36 of the heat exchanger 26, or afterward, can be set as precisely as possible to the desired value (nominal temperature of the ink).

The heat exchanger 26 is preferably designed as a plate heat exchanger in which the thermal energy is transferred via the wall having good thermal conductivity. The two material streams are thereby not in direct contact, but rather are spatially (physically, bodily) separated by the heat-permeable wall. The wall or cladding that separates the two material streams should have a good thermal conductivity and a large surface area so that the thermal energy can be transferred as effectively as possible. The greater the design of the area of the plate, the more thermally conductive the wall between them, and the thinner the wall the more effective the thermal transfer. The fluid-conducting and ink-conducting parts of the plate heat exchanger are preferably produced from corrosion-resistant steel.

The ink tempered in such a manner is supplied to the printing unit 40. This can have a distribution tank 44 that distributes to one or more print heads 42 with which this same ink is respectively printed. Distribution tank 44 and possible degassing unit (not shown) can also be arranged in the print head unit itself.

A separate tempering device 10 is provided for each print color (for example an ink with a defined color), which tempering device 10 then forwards the corresponding ink to the corresponding print heads 42 so that this color can also be printed with corresponding print heads 42. Each ink typically has its own nominal temperature/optimal operating temperature at which an optimal print quality is achieved. However, it is sufficient if all control devices 22 are fed from the same fluid source 12 with the same pre-tempered tempering fluid.

The conduit paths between the regulating device 22 and the heat exchanger 26, and between the heat exchanger 26 and the distribution tank 44, should be relatively short so that optimally little heat loss—which would negatively affect the accuracy of the regulation of the ink temperature (nominal temperature)—occurs along the fluid conduits 18 and the ink conduits 38, and/or should be thermally insulated. However, since the real temperature of the ink is measured and regulated to nominal temperature, the conduit lengths play a subordinate role insofar as the real temperature is measured near the “consumption.” There is only a greater regulation demand. Given large conduit lengths, it can take longer until the operating temperature of the ink is reached, since more energy must be expended due to the greater energy losses.

The flow paths of the material streams (tempering fluid and ink) are predetermined by corresponding conduits 18, 33, 38. The conduits 18, 33, 38 can be tubular in design and consist of metal, plastic, or other suitable materials such as composites. They should additionally be corrosion-resistant. The material streams thereby accordingly flow in the direction in the conduits 18, 33, 38 as they are represented by the arrows in FIGS. 1 and 2.

A workflow diagram of a method for operating a tempering device 10 as it has been described in conjunction with FIG. 1 is depicted in FIG. 3. First, in step S1 a tempering fluid is thereby provided at a predefined, largely constant temperature. In step S2, the tempering fluid is supplied to a regulating device 22 that regulates a volumetric flow per time period, depending on a measured real temperature and the difference relative to a nominal temperature, in order to bring the ink to a desired temperature (nominal temperature) and keep it there (in step S3).

In step S4, the tempering fluid is supplied to a heat exchanger 26 where it is brought into thermal contact with an ink to be printed, which ink likewise flows through the heat exchanger 26. Thermal energy is thereby transferred from the mixture fluid to the ink. The level of the thermal energy is dependent on the mass throughput of tempering fluid that is supplied to the heat exchanger 26.

In the regulation, the actual ink temperature (real value) is measured continuously or intermittently, and the real value is fed back to the regulating device 22 for regulation (step S5). There, for regulation the volumetric flow is then continuously varied in step S6, depending on the nominal/real value difference, until the real value reaches the nominal value of the ink temperature. Afterward, regulation continues in order to largely maintain the nominal value. The changes to the volumetric flow that are performed are then smaller. The actual printing can be begun in this state.

The ink is tempered via the thermal transfer from the tempering fluid to the ink. The goal is to achieve a desired temperature of the ink at the exit from the heat exchanger 26, which desired temperature already corresponds to the nominal temperature or is close thereto. For this purpose, the volumetric flow is varied and regulated further until the desired nominal temperature of the ink is achieved. As long as the difference between real value and nominal value of the ink temperature is still large, a greater volumetric flow is required (i.e. more energy is provided), whereas later, when the nominal value is reached, only a smaller volumetric flow (i.e. less energy) is still required in order to maintain the nominal value. The control expenditure thus decreases after bringing the ink up to temperature.

With this tempering device 10, it is possible to adjust every nominal temperature of every individual print color. At the input side, it is only necessary to have one fluid source 12 with a pre-tempered tempering fluid whose temperature is higher than the desired nominal value of the ink temperature.

The accuracy of the temperature adjustment of the nominal temperature thereby depends essentially on the regulation of the volumetric flow of the tempering fluid. The precise maintenance of the temperature level of the input-side tempering fluid in the fluid source 12 is thereby of subordinate importance, since the actual precise temperature adjustment via the regulating device 22 takes place by feeding back the measured ink temperature and comparing it with the nominal temperature. This means that the temperature level of the input-side fluid source does not need to be highly precise, and can even fluctuate slightly.

With this tempering device 10, the ink can only be heated. The more rapidly that the ink is brought to nominal temperature, the shorter the wait time or delay until the printing can be begun. Therefore, it is important that the predetermined fluid temperature is higher by a few degrees of temperature. Initially, a greater volumetric flow per time period then more rapidly heats the ink. Afterward, the regulating activity decreases steadily, meaning that the changes to the volumetric flow become smaller, until the nominal temperature is reached. In the steady state, only very little regulation must still take place, since the ink must only be maintained at nominal temperature.

The temperature sensors 24 as such are sufficiently known. All suitable temperature sensor 24, such as NTC thermistors, PTC thermistors, thermocouples, Peltier elements etc. that supply an electrical signal as a measure of the temperature can be used to measure temperatures of fluids. The temperature of a fluid is preferably measured directly in the fluid. If the temperature is measured from outside the fluid conduit 18, the measured value may deviate somewhat from the fluid temperature. A small correction thus would need to be performed in order to use the measured temperature for the regulation. A plurality of temperature sensors 24 can be present that measure the ink temperature and feed the real value back to the regulating device 22.

In the exemplary embodiment according to FIG. 1, the real temperature of the ink is measured at the output of the heat exchanger 26 or shortly afterward, wherein the temperature sensor 24 measures the temperature most precisely directly within the fluid. The temperature of the ink can also be measured in the print heads 42. This has the advantage that the temperature is also measured where it should actually be present. The regulation can thus be more precise. In all instances, a measured temperature value (real value) is fed back to the regulating device 22, and there the volumetric flow is adjusted accordingly from the difference between real value and nominal value.

The tempering device 10 according to the invention requires only one fluid source 12 in which a fluid temperature is preset that is higher than the specified operating temperature of the ink. The current real temperature of the ink in the reservoir 28 depends on the ambient temperature. After activation of the ink printer, the ink must initially be brought to operating temperature via the regulation with the tempering device 10 and then be maintained approximately at operating temperature during the operation. It is also advantageous to already heat the ink in the ink reservoir 28 to a defined temperature below the nominal temperature so that the ink can be regulated to operating temperature more quickly.

What are to be understood by the term “ink” are, in general, “print colors” that are colorant-containing tempering fluids and with which a printing substrate (recording medium 46) is printed to with the aid of print heads 42 to generate the print image, and therewith a print good. Water-based print colors such as aqueous inks are preferably used. However, other print colors that are not water-based may also be used.

The term “color” relates only to the actual color of the colorant, for example the colors YMCK (Yellow, Magenta, Cyan, Black) that are often used in printing technology, or RGB (Red, Yellow, Blue) together with black.

The term “printing substrate” refers to the base material on which printing takes place. The printing substrate can be comprised of paper, plastics (polymers), or other suitable materials or mixed materials.

Every ink has a value for the operating temperature value that has already been specified by the manufacturer and which represents the optimal temperature for the printing operation. This value can also be referred to as a nominal value. In the printing operation, the ink should be tempered to this value in order to achieve an optimal print quality of the print image. The manufacturer also specifies a narrow tolerance range within which an allowable deviation of the ink temperature is possible without there being losses in print quality. The ink should thus be tempered to the nominal value and also be maintained there (within the tolerance range) during the printing. Deviations within the tolerance range are harmless to the print quality. For example, the specified temperature value can be 32° C., with a tolerance range of approximately ±1° C.

Furthermore, the manufacturer of the ink also specifies a maximum temperature that the ink should not exceed so that it is not damaged.

Via the regulation with the tempering device 10, the ink is initially quickly brought to operating temperature and then largely held at this level, even if the temperature of the fluid in the fluid source 12 should fluctuate somewhat.

In general, no damage to the ink should occur due to overheating or overcooling, not even should the regulating device 22 or the heat exchanger 26 at least partially fail or be disrupted. The fluid is therefore preset to a temperature value higher than the desired operating temperature, but not higher than the maximum allowable ink temperature. As a result of this, the ink temperature can never rise to a higher temperature than the maximum allowable temperature.

Printing units of an ink printer are sufficiently known and do not need to be explained in detail here. For the invention, the manner of application of the ink and the type of the printing substrate play a subordinate role.

The PI controller 25 (proportion-integral controller) consists of the parts of a P-element (proportional element) and an I-element (integral element), with a time constant. It can be defined both from a parallel structure or from a serial structure. Of course, other suitable controllers 25 or control units can also be used that, depending on the current real value of the ink temperature, regulate the volumetric flow through the fluid loop of the heat exchanger 26 so that the desired operating temperature/nominal temperature of the ink is already achieved after an optimally short time and is held at this level. This occurs via a regulation that controls the volumetric flow per time period so that ultimately the nominal temperature is achieved and maintained. In an exemplary embodiment, the controller 25 may include processing circuitry that is configured to perform one or more functions and/or operations of the controller 25. In an exemplary embodiment, the controller 25 includes one or more interfaces (e.g. a wired and/or wireless input and/or output interface, transceiver, or the like) that is configured to receive or output data or information. In an exemplary embodiment, the controller 25 includes a memory configured to store data/information, and/or store executable code that is executable by the processing circuitry to cause the processing circuitry to perform the operation(s) of the controller 25.

A “fluid” is a comprehensive term for liquids, gases, and plasmas. A thermal energy can be transferred in the heat exchanger 26 by means of a fluid via thermal conduction. The volumetric flow (or flow rate/mass throughput) thereby indicates how much volume of a fluid is transported through a defined cross section per time period. The thermal transfer in the heat exchanger 26 is controlled by accordingly varying the volumetric flows of the tempering fluid. The volumetric flow can be varied simply and quickly as needed via a corresponding controllable valve (advantageously a proportional valve 23).

In FIG. 1, a tempering device 10 is depicted only for the color yellow (Y) with its distribution tank 44 (D_{Y}). The respective distribution tank 44 (here D_{M}, D_{C}, and D_{K}) with the associated supply conduits to the print bars (here four print heads 42 in a row per color) are depicted only representatively for the other primary colors magenta (M), cyan (C), and black (K). Of course, printing can also be done with other primary colors such as RGB (red, yellow, blue, as well as black). Additional colors or other liquids, such as functional liquids, can likewise be printed with the print heads 42, wherein each of these inks thus has its own heat exchanger 26, since otherwise the inks would be mixed.

In FIG. 2, the tempering device 10 for a yellow (Y) and magenta-colored (M) ink are depicted representatively for a plurality of inks to be printed. Only a single fluid source 12 is thereby required to regulate the ink temperature of the various inks, in which fluid source 12 the pre-tempered fluid is provided for the regulating devices 22 with subsequent heat exchangers 26 (WT_{Y} for the yellow ink and WT_{M} for the magenta ink). After the respective heat exchangers 26, the tempering fluid is conducted back to the fluid source 12, where it is tempered again to the preset fluid temperature.

The composition of the inks and print colors themselves are of secondary priority for the invention, since it is essential that the aspect of the specified operating temperature of the liquid to be printed be complied with, independently of its chemical composition, even if the composition influences the specified temperature of the liquid to be printed. In addition to this, the maximum allowable temperature of the respective ink is still possibly to be observed for the pre-setting of the fluid temperature.

A “heat exchanger” or “thermal transfer medium” is a device that transfers thermal energy from one material stream to another. The possible design embodiments of heat exchangers 26 as such are sufficiently known and do not need to be described in detail here. In terms of its basic function, two fluids respectively flow through the heat exchanger 26 in order to bring these to a predetermined thermodynamic state. The thermal power emitted by the warmer stream (here tempering fluid) and simultaneously absorbed by the cold stream (here ink) is used to temper the ink in terms of its temperature.

The “volumetric flow” (or, less precisely, flow rate and mass throughput) is a physical variable that indicates how much volume of the tempering fluid is transported per time period (and therefore, how much energy per time) through a defined cross section. The volumetric flow that is being varied by the regulation is controlled by the proportional valve 23 to regulate the desired nominal temperature. Fundamentally, that quantity of energy is thereby regulated that is available per time period for heating the ink.

A proportional valve 23 is a proportional servo valve that, with the aid of a proportional magnet, permits not only discrete switching positions but rather a steady transition of the valve opening. Proportional valves 23 are used in hydraulics and pneumatics especially where variable volumetric flows are required. Proportional valve 23 are electromagnetic or medium-controlled valves that can assume arbitrary intermediate positions between open and closed. Such volumetric flow controllers for variable volumetric flow normally operate electronically and receive from the superordinate controller 25 nominal values for the fluid quantity that is necessary to regulate the desired ink temperature. Of course, other valves can also be used that can be controlled electrically, hydraulically, or electromagnetically in order to achieve a desired volumetric flow.

The effectiveness of the heat exchanger 26 is dependent on the two entrance temperatures of ink and tempering fluid, the transferred thermal power, and in particular on the flow configuration of both fluid streams through the heat exchanger 26, for example a parallel flow, a counter-flow, a cross-flow, or even a counter-flow vortex configuration. It is thereby essential that the thermal heat transfer occurs effectively and rapidly. The desired and specified nominal ink temperature can thus be achieved quickly and without large heat losses.

In order to achieve a better effectiveness, and to achieve a more rapid nominal temperature of the ink, the ink in the ink reservoir 28 can be roughly pre-tempered to a temperature near to the nominal temperature. If there is a large temperature difference between the ink temperature in the ink reservoir 28 and the nominal temperature of the ink at the ink exit 36 of the heat exchanger 26, the regulation to nominal temperature takes significantly longer and is more expensive in terms of energy.

In addition to the material properties of the heat exchanger 26, the efficacy of the thermal transfer is determined from the geometric configuration of the material streams with respect to one another.

The tempering device 10 has the advantage that a variable volumetric flow of a tempered fluid serves to adjust the desired ink temperature. If the tempered fluid is set to a temperature approximately the same as or only slightly higher than the maximum allowable ink temperature, the ink temperature can thus never be higher than the temperature of the tempering fluid. After the fluid source 12, the tempering fluid is no longer tempered; rather, by contrast, it suffers heat losses upon flowing through fluid conduits 18, control device 22, and heat exchanger 26, which leads to a small temperature decrease of the tempering fluid on the way to the heat exchanger 26. Moreover, the tempering fluid does not need to be tempered precisely to its temperature. Fluctuations of the temperature of the tempering fluid in the fluid source 12 are compensated for by the accurate regulation via the volumetric flow to the heat exchanger 26.

It can also be provided that the temperature of the tempering fluid is changed during operation in the event that a quicker regulation would therewith be possible under the given conditions, such as ambient temperature, ink temperature in the ink reservoir 28, or the temperature of the fluid that is supplied to the fluid source 12.

The quantity of the volumetric flow does not need to be measured, because only the real temperature of the ink close to the “consumption” is measured as a control variable. The ambient temperature likewise does not need to be taken into account. It is only a disturbance variable that influences the ink temperature in the ink reservoir 28 or the fluid temperature in the fluid source 12 in the event that it has not yet been pre-tempered. The heating time is thus shortened or lengthened depending on the level of the ambient temperature.

The ink can be rapidly brought to its operating temperature with this tempering device 10. The conduit lengths have no influence on the accuracy of the regulation, but rather at most on the duration of the heating of the ink up to operating temperature. The conduits should therefore be kept as short as possible so that there is not excessive heat loss and the regulation can operate quickly enough. A separate fluid source 12 with tempering is also not required for every ink. Fewer electronic modules are thus necessary. Every ink has its own control loop (regulating device 22, heat exchanger 26, as well as temperature sensor 24 with feedback of the measured real value to the regulating device 22) to regulate the ink to its own respective operating temperature. Only the fluid source 12 is common to all inks that are printed in the ink printer. In printing operation, the ink thus always remains within the specified tolerance range, and that is independent of the print job that is presently being executed.

### REFERENCE LIST

12 fluid source
13 heating element
15 cooling element
16 outflow
18 fluid conduit
19 output (of the control device)
20 inflow
21 supply connection
22 regulating device
23 proportional valve
24 temperature sensor
25 controller
26 heat exchanger
27 return flow
28 ink reservoir
29 return line
30 fluid entrance
32 fluid exit
32 fluid exit
34 ink entrance
36 ink exit
40 printing unit
42 print head
44, D_{Y}, D_{M}, D_{C}, D_{K} distribution tank
46 recording medium
YMCK colors
WT_{Y}, WT_{M} heat exchanger yellow, magenta

1. A tempering device for tempering ink for an ink printer, having:
a fluid source with a tempering fluid that is pre-tempered to a predetermined temperature and that is provided at an outflow of the fluid source,
a regulating device with an input that is connected via a fluid conduit with the outflow of the fluid source, a control unit that controls a mass throughput of the supplied tempering fluid depending on a measured temperature of the ink to be tempered as a control variable, and with an output at which the tempering fluid is provided as a correcting variable,
a heat exchanger with a fluid loop and an ink loop that both are in thermal contact with one another but are physically separate from one another, for transfer of thermal energy from the fluid loop to the ink loop, wherein the fluid loop is connected with the regulating device in order to feed the fluid loop with the tempering fluid, and wherein the ink loop is connected with an ink reservoir in order to feed the ink loop with ink to be tempered to a nominal temperature,
at least one temperature sensor that is arranged at or after the heat exchanger and is electrically connected with the regulating device, wherein the temperature sensor measures the temperature of the ink as a real value and feeds the real value back to the control unit of the regulating device in order to regulate the temperature of the ink to its desired temperature.

2. The tempering device according to claim 1, wherein the heat exchanger is a plate heat exchanger.

3. The tempering device according to claim 1, wherein the fluid source has a heating element and/or a cooling element as tempering elements, via which the tempering fluid is tempered to a predetermined fluid temperature.

4. The tempering device according to claim 1, wherein the tempering fluid is water with possibly added additives.

5. The tempering device according to claim 4, wherein the fluid source is fed with water from a domestic connection for refilling or filling of the fluid source with water.

6. The tempering device according to claim 1, wherein the fluid source has a temperature sensor to measure a temperature of the tempering fluid.

7. The tempering device according to claim 1, wherein at least one temperature sensor that measures the temperature of the ink within the ink conduit is arranged directly at an ink exit or after the ink exit of the heat exchanger.

8. The tempering device according to claim 1, wherein the control unit of the regulating device has a controller and a controllable valve and the control unit is connected with the temperature sensor for measuring the ink temperature in order to control a volumetric flow per time of the tempering fluid depending on a real value of the ink and the difference relative to a desired nominal value, in order to bring the ink to operating temperature.

9. The tempering device according to claim 8, wherein the controller is a PI controller and the valve is a proportional valve.

10. A method for operating the ink tempering device for the ink printer with a tempering device according to claim 1, the method comprising
providing the tempering fluid that is pre-tempered to a predetermined temperature,
supplying the tempering fluid to the regulating device,
regulating the mass throughput per time of the tempering fluid via the regulating device, depending on the measured real value of the ink temperature,
bringing the tempering fluid into thermal contact with the ink in the heat exchanger, whereby thermal energy is transferred from the tempering fluid to the ink to be printed in order to bring the ink to the desired nominal temperature, and
measuring the ink temperature after an output of the heat exchanger, and feeding the measured real value back to the regulating device to regulate the ink temperature.
